(19) United States
(12) Patent Application Publication
(10) Pub. No.: US 2025/0198138 A1
(43) Pub. Date: Jun. 19, 2025

(54) FILTERING SHOWER SUPPORT ARM

(71) Applicant: Xiamen Aokecheng Technology Co., Ltd, Xiamen (CN)

(72) Inventor: Shengwu ZHANG, Xiamen (CN)

(73) Assignee: Xiamen Aokecheng Technology Co., Ltd, Xiamen (CN)

(21) Appl. No.: 18/435,813

(22) Filed: Feb. 7, 2024

(30) Foreign Application Priority Data
Dec. 19, 2023 (CN) 202323495459.7

(51) Int. Cl. E03C 1/04; B05B 15/40; B05B 15/65; E03C 1/02

(52) U.S. Cl. CPC E03C 1/0408; B05B 15/40; B05B 15/65; E03C 2001/026; E03C 2201/40

(57) ABSTRACT

Disclosed is a filtering shower support arm, which includes a fixed support arm, a swing support arm, a tee joint, a water passing pipe and a filter. One end of the fixed support arm is fixedly installed on a wall, and is provided with a water inlet channel, and the other end is swingably assembled with the swing support arm, and is provided with a water passing channel communicating with a water path in the swing support arm. The periphery of the fixed support arm is provided with a first joint and a second joint, which respectively communicate with the water inlet channel and the water passing channel. The filtering shower support arm provided by the application has flexible assembly modes, and can form different assemblies according to demands of consumers, particularly, the installation position of the filter may be determined according to water demands.

### CROSS-REFERENCE TO RELATED APPLICATIONS

This application claims priority to Chinese Patent Application No. 202323495459.7, filed on Dec. 19, 2023, which is incorporated herein by reference in its entirety.

### TECHNICAL FIELD

The application relates to the technical field of kitchens and bathrooms, and in particular to a filtering shower support arm.

### BACKGROUND

A shower support arm generally is butted with a water outlet pipe joint pre-buried in a wall, and has a top shower installed at the other end, which has the advantage of simple structure. As the demand of consumers increases, the structure of the shower support arm is further improved, for example, a tee joint is added, so that a top shower and a shower head may be installed at the same time, and more use choices are provided for the consumers. In addition, some shower support arms are additionally provided with filters, so that filtering treatment may be carried out on outgoing water. At present, the shower support arm on the market is generally relatively simple and fixed in structure, has low flexibility, and cannot be subjected to DIY assembly according to demands of a user, and therefore, the application provides a shower support arm with high flexibility.

### SUMMARY

In order to solve the above technical problem, the application provides a structure of a filtering shower support arm with high assembly flexibility. A filtering shower support arm includes a fixed support arm, a swing support arm, a tee joint, a water passing pipe and a filter.

One end of the fixed support arm is fixedly installed on a wall, and is provided with a water inlet channel for introducing a water source, and the other end is swingably assembled with the swing support arm, and is provided with a water passing channel communicating with a water path in the swing support arm. The periphery of the fixed support arm is provided with a first joint and a second joint, the first joint communicates with the water inlet channel, and the second joint communicates with the water passing channel.

The tee joint is provided with a water inlet joint, a first water outlet joint, a second water outlet joint and a switching valve, and the water passing pipe is a hose, so that possibility is provided for various assembly modes.

The assembled filtering shower support arm has the following assembled states.

The first joint communicates with the water inlet joint through the filter, and the second joint communicates with the second water outlet joint through the water passing pipe. Or, the first joint communicates with the water inlet joint, and the second joint communicates with the second water outlet joint through the water passing pipe and the filter. Or, the first joint communicates with the water inlet joint, the second joint communicates with the second water outlet joint through the water passing pipe, and the filter is butted with the first water outlet joint.

The filtering shower support arm provided by the application has flexible assembly modes, and can form different assemblies according to demands of consumers, particularly, the installation position of the filter may be determined according to water demands, so that the mode of filtering all outgoing water, only filtering water from the top shower or only filtering water from the shower head is formed, and more choices are provided for users.

Preferably, the fixed support arm is installed in a horizontal state, the first joint is vertical downwards, and when the filter is installed between the fixed support arm and the tee joint, shearing force suffered by the filter may be reduced, thus prolonging the service life of the filter.

Preferably, the filter adopts a water inlet joint of an inner spiral tooth type and a water outlet joint of an external spiral tooth type, thus being capable of being installed on each position flexibly.

Preferably, the first joint, the second joint, the first water outlet joint and the second water outlet joint all adopt joints of an external spiral tooth type, and joints of an inner spiral tooth type are adopted at both ends of the water inlet joint and the water passing pipe.

Preferably, when the second joint communicates with the second water outlet joint through the water passing pipe and the filter, the filter is directly butted with the second joint.

Preferably, an extension pipe is included, which is disposed between the first joint and the water inlet joint, so that the installation height of the tee joint may be reduced.

Preferably, the first joint, the extension pipe and the water inlet joint are sequentially butted, or the first joint, the filter, the extension pipe and the water inlet joint are sequentially butted, or the first joint, the extension pipe, the filter and the water inlet joint are sequentially butted.

Preferably, a lifting shower seat is disposed on the extension pipe, so that more comprehensive bathing experience is provided for consumers.

Preferably, pipe fittings where the water inlet channel and the water passing channel are located are assembled through welding, so that the connection is reliable.

Preferably, a swing seat is installed at the tail end of the swing support arm in a swing mode, so that the flexibility of the top shower is further improved.

As can be seen from the above description of the application, the application has the following beneficial effects.

The filtering shower support arm provided by the application has flexible assembly modes, and can form different assemblies according to demands of consumers, particularly, the installation position of the filter may be determined according to water demands, so that the mode of filtering all outgoing water, only filtering water from the top shower or only filtering water from the shower head is formed, and more choices are provided for users.

The fixed support arm is installed in a horizontal state, the first joint is vertical downwards, and when the filter is installed between the fixed support arm and the tee joint, shearing force suffered by the filter may be reduced, thus prolonging the service life of the filter.

Different joints are adopted at two ends of the filter, so that it may be installed on each position flexibly.

An extension pipe is disposed, so that the installation height of the tee joint may be reduced, and meanwhile, a lifting seat may be installed.

### BRIEF DESCRIPTION OF THE DRAWINGS

The accompanying drawings described herein are used to provide a further understanding of the application and constitute a part of the application, and the exemplary embodiments of the application and the description thereof are used to explain the application, but do not constitute improper limitations to the application.

FIG. 1 is a diagram I of an axial side view of a filtering shower support arm (first assembly state).

FIG. 2 is a diagram II of an axial side view of a filtering shower support arm.

FIG. 3 is a diagram III of an axial side view of a filtering shower support arm.

FIG. 4 is a diagram IV of an axial side view of a filtering shower support arm.

FIG. 5 is a diagram of a front view of a filtering shower support arm.

FIG. 6 is a diagram of a side view of a filtering shower support arm.

FIG. 7 is a diagram of a sectional view of a filtering shower support arm (about A-A of FIG. 5).

FIG. 8 is a diagram V of an axial side view of a filtering shower support arm (second assembly state).

FIG. 9 is a diagram VI of an axial side view of a filtering shower support arm (third assembly state).

### DETAILED DESCRIPTION OF THE EMBODIMENTS

In order to make the technical problem, the technical solution and the beneficial effects of the application clearer, the application will be further described in detail below in combination with drawings and embodiments. It is to be understood that the specific embodiments described herein are for the purpose of explaining the application only and are not intended to limit the application.

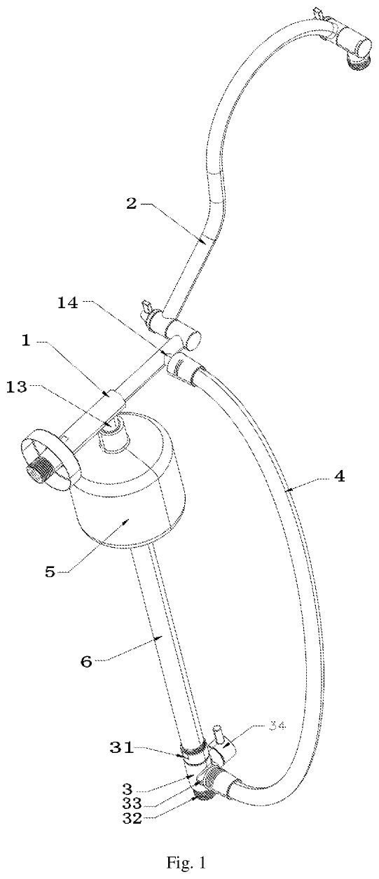

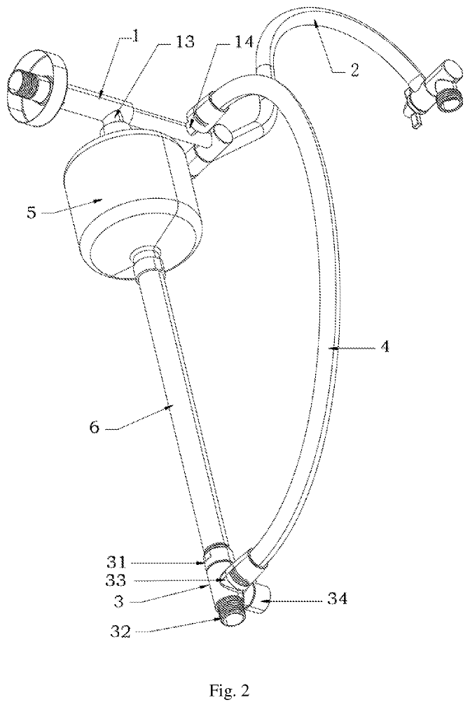

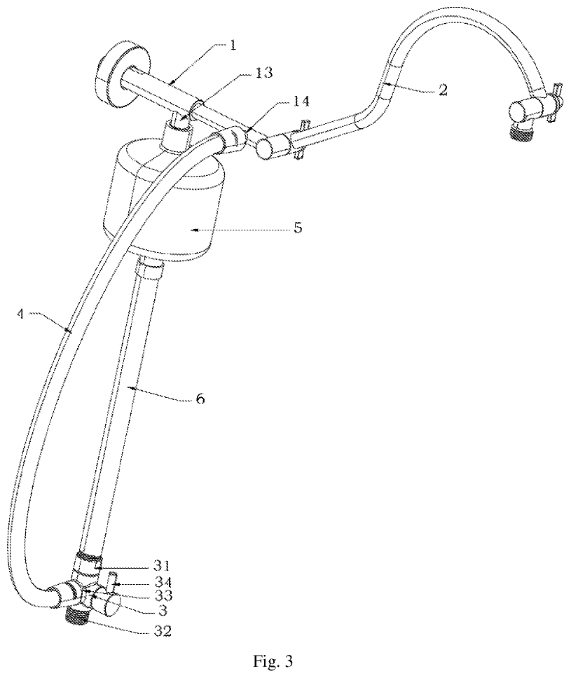

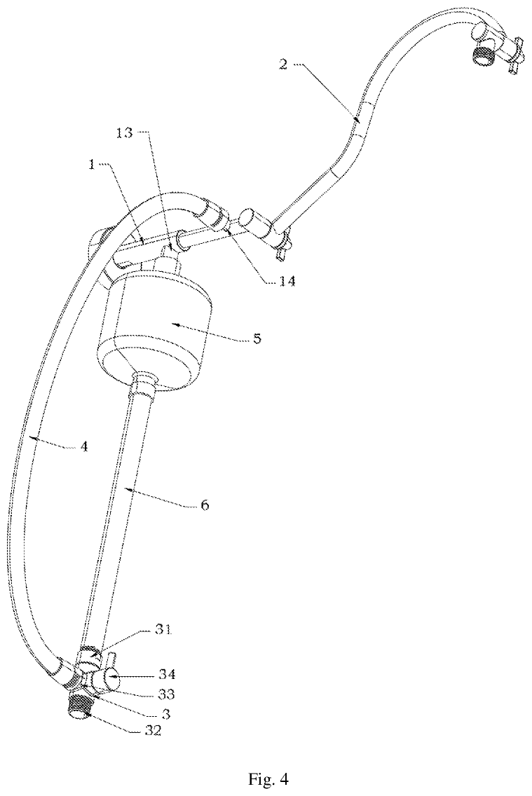

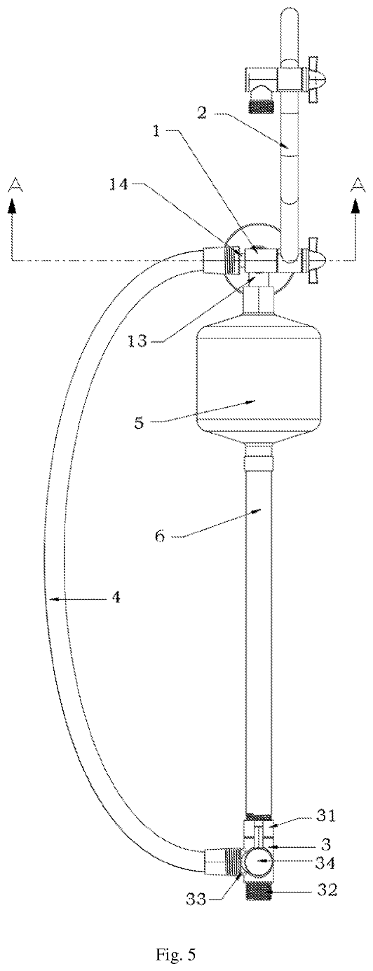

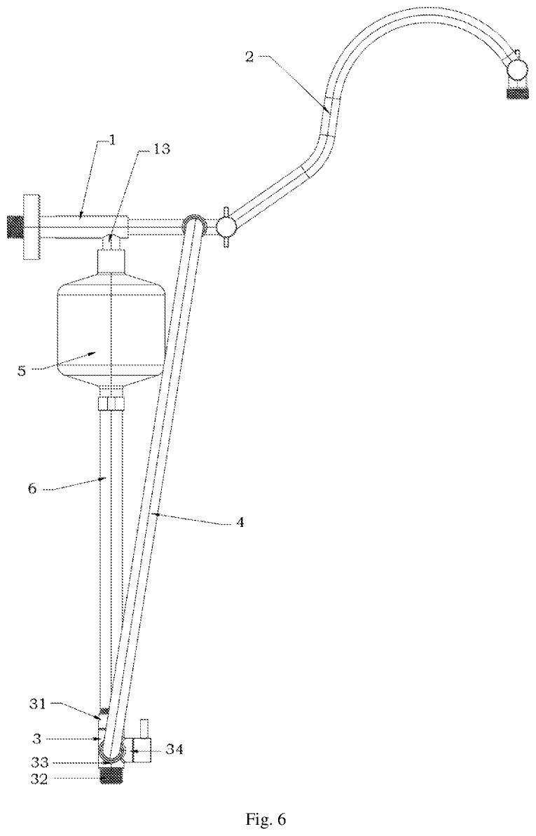

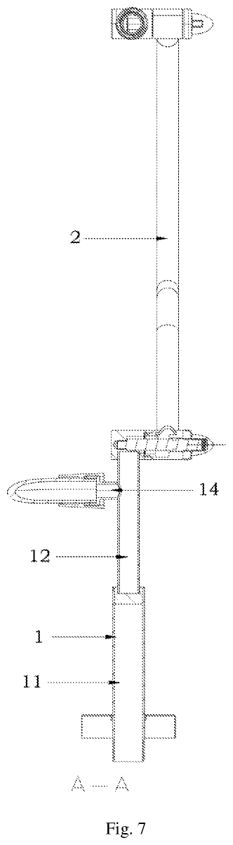

Referring to FIGS. 1-7, a filtering shower support arm includes a fixed support arm 1, a swing support arm 2, a tee joint 3, a water passing pipe 4 and a filter 5.

One end of the fixed support arm 1 is fixedly installed on a wall, and is provided with a water inlet channel 11 for introducing a water source, and the other end is swingably assembled with the swing support arm 2, and is provided with a water passing channel 12 communicating with a water path in the swing support arm 2. The periphery of the fixed support arm 1 is provided with a first joint 13 and a second joint 14, the first joint 13 communicates with the water inlet channel 11, and the second joint 14 communicates with the water passing channel 12.

The tee joint 3 is provided with a water inlet joint 31, a first water outlet joint 32, a second water outlet joint 33 and a switching valve 34, and the water passing pipe 4 is a hose, so that possibility is provided for various assembly modes.

In an embodiment, in order to avoid that some adapters need to be combined when the position of the filter 5 is adjusted, the filter 5 adopts a water inlet joint 31 of an inner spiral tooth type and a water outlet joint of an external spiral tooth type, the first joint 13, the second joint 14, the first water outlet joint 32 and the second water outlet joint 33 all adopt joints of an external spiral tooth type, and joints of an inner spiral tooth type are adopted at both ends of the water inlet joint 31 and the water passing pipe 4.

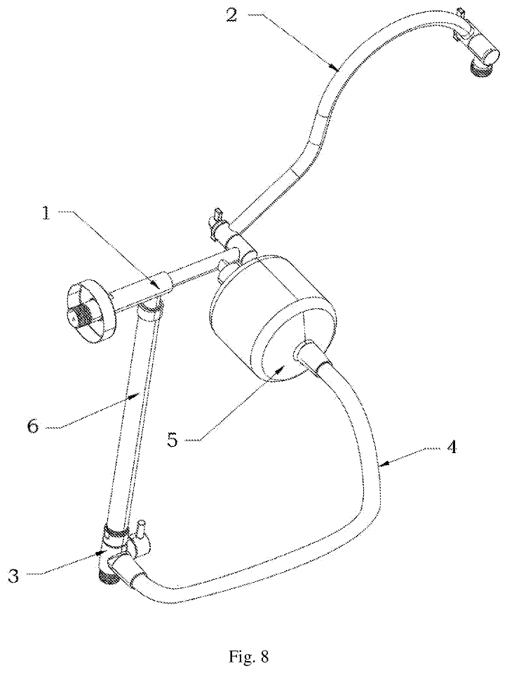

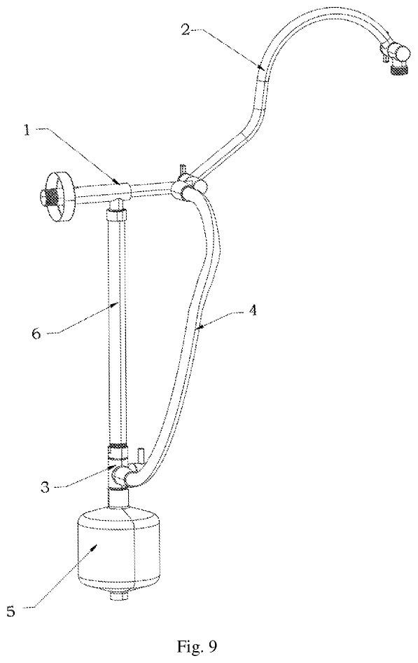

The assembled filtering shower support arm has the following assembled states.
1. The first joint 13 communicates with the water inlet joint 31 through the filter 5, and the second joint 14 communicates with the second water outlet joint 33 through the water passing pipe 4, as shown in FIGS. 1-7.
2. The first joint 13 communicates with the water inlet joint 31, and the second joint 14 communicates with the second water outlet joint 33 through the water passing pipe 4 and the filter 5, as shown in FIG. 8.
3. The first joint 13 communicates with the water inlet joint 31, and the second joint 14 communicates with the second water outlet joint 33 through the water passing pipe 4, and the filter 5 is butted with the first water outlet joint 32, as shown in FIG. 9.

In an embodiment, the fixed support arm 1 is installed in a horizontal state, the first joint 13 is vertical downwards, and when the filter 5 is installed between the fixed support arm 1 and the tee joint, shearing force suffered by the filter 5 may be reduced, thus prolonging the service life of the filter 5. In addition, in order to improve the strength and reliability of the fixed support arm 1, pipe fittings where the water inlet channel 11 and the water passing channel 12 are assembled through welding.

In order to match consumers of different heights, in an embodiment, an extension pipe 6 is included, the extension pipe 6 is disposed between the first joint 13 and the water inlet joint 31, so that the installation height of the tee joint 3 may be reduced. The first joint 13, the extension pipe 6 and the water inlet joint 31 are sequentially butted, or the first joint 13, the filter 5, the extension pipe 6 and the water inlet joint 31 are sequentially butted, or the first joint 13, the extension pipe 6, the filter 5 and the water inlet joint 31 are sequentially butted. Preferably, a lifting shower seat is disposed on the extension pipe 6, so that more comprehensive bathing experience is provided for consumers. The filtering shower support arm provided by the application has flexible assembly modes, and can form different assemblies according to demands of consumers, particularly, the installation position of the filter 5 may be determined according to water demands, so that the mode of filtering all outgoing water, only filtering water from the top shower or only filtering water from the shower head is formed, and more choices are provided for users.

The application has been described exemplarily in combination with accompanying drawings, it is apparent that the specific implementation of the application is not limited by the above mode, various non-substantive improvement made by adopting the method conception and technical solutions of the application, or direct application of the conception and technical solutions of the application to other occasions without improvement all fall within the protection scope of the application.

What is claimed is:

1. A filtering shower support arm, comprising a fixed support arm, a swing support arm and a tee joint; wherein
one end of the fixed support arm is fixedly installed on a wall, and is provided with a water inlet channel, and an other end is swingably assembled with the swing support arm, and is provided with a water passing channel communicating with a water path in the swing support arm; a periphery of the fixed support arm is provided with a first joint and a second joint, the first joint communicates with the water inlet channel, and the second joint communicates with the water passing channel;
the tee joint is provided with a water inlet joint, a first water outlet joint, a second water outlet joint and a switching valve; and
the first joint communicates with the water inlet joint through the filter, and the second joint communicates with the second water outlet joint.

2. The filtering shower support arm according to claim 1, further comprising a water passing pipe and a filter, wherein the water passing pipe is a hose; the first joint communicates with the water inlet joint through the filter, and the second joint communicates with the second water outlet joint through the water passing pipe.

3. The filtering shower support arm according to claim 1, further comprising a water passing pipe and a filter, wherein the water passing pipe is a hose; the second joint communicates with the second water outlet joint through the water passing pipe and the filter.

4. The filtering shower support arm according to claim 1, further comprising a water passing pipe and a filter, wherein the water passing pipe is a hose; the second joint communicates with the second water outlet joint through the water passing pipe, and the filter is butted with the first water outlet joint.

5. The filtering shower support arm according to claim 1, wherein the fixed support arm is installed in a horizontal state, and the first joint is vertically downwards.

6. The filtering shower support arm according to claim 3, wherein the filter adopts a water inlet joint of an inner spiral tooth type and a water outlet joint of an external spiral tooth type.

7. The filtering shower support arm according to claim 6, wherein the first joint, the second joint, the first water outlet joint and the second water outlet joint all adopt joints of an external spiral tooth type, and joints of an inner spiral tooth type are adopted at both ends of the water inlet joint and the water passing pipe.

8. The filtering shower support arm according to claim 7, wherein when the second joint communicates with the second water outlet joint through the water passing pipe and the filter, the filter is directly butted with the second joint.

9. The filtering shower support arm according to claim 2, further comprising an extension pipe disposed between the first joint and the water inlet joint.

10. The filtering shower support arm according to claim 9, further comprising an extension pipe disposed between the first joint and the water inlet joint, and the first joint, the extension pipe and the water inlet joint are sequentially butted.

11. The filtering shower support arm according to claim 9, wherein the first joint, the filter, the extension pipe and the water inlet joint are sequentially butted.

12. The filtering shower support arm according to claim 9, wherein the first joint, the extension pipe, the filter and the water inlet joint are sequentially butted.

13. The filtering shower support arm according to claim 9, wherein a lifting shower seat is disposed on the extension pipe.

14. The filtering shower support arm according to claim 1, wherein pipe fittings where the water inlet channel and the water passing channel are located are assembled through welding.

15. The filtering shower support arm according to claim 1, wherein a swing seat is installed at a tail end of the swing support arm in a swing mode.
